(19) United States
(12) Patent Application Publication
(10) Pub. No.: US 2013/0329192 A1
(43) Pub. Date: Dec. 12, 2013

(54) COMBINATION STRUCTURE FOR ADJUSTING THE CLEARANCE OF PROJECTED IMAGES

(71) Applicants: CHIH-DER CHUAN, Hu Kou Township (TW); Tze-Yun Sung, Hu Kou Township (TW)

(72) Inventors: CHIH-DER CHUAN, Hu Kou Township (TW); Tze-Yun Sung, Hu Kou Township (TW)

(21) Appl. No.: 13/494,977

(22) Filed: Jun. 12, 2012

(51) Int. Cl. G03B 21/14

(52) U.S. Cl. 353/20

(57) ABSTRACT

A combination structure for adjusting the clearance of projected images includes a micro projecting panel, a micro projector body, an elastic spring, a quarter wave plate set and an adjusting screw. The micro projecting panel is arranged at the peripheral of a projecting window of the micro projector body. The quarter wave plate set is inserted into an adjusting groove of the micro projector body. A supporting arm of the quarter wave plate set is arranged in an axial hole of the micro projector body. The elastic spring and the adjusting screw are arranged into the axial hole of the micro projector body. The adjusting screw is adjusted for finely adjusting the space between the quarter wave plate set and the micro projecting panel. By applying the combination structure, the clearance of projected images can be improved.

### BACKGROUND OF THE DISCLOSURE

a) Field of the Disclosure The present disclosure relates to a combination structure for adjusting the clearance of projected images, in particularly to a combination structure for adjusting the clearance of images projected from a micro projector.

b) Brief Description of the Related Art

The contrast ratio of traditional image projector will directly affect the quality of projected images. In order to improve the contrast ratio, a quarter wave plate is usually arranged in front of the projecting panel as an important component for improving the quality of projected images. In case of micro projector with extremely small room, the quarter wave plate should be chosen to abandon. If the quarter wave plate is forced to be arranged in front of the panel, the design of the mechanism can not allow the quarter wave plate to be adjusted for tuning the contrast ratio. This kind of combination structure can not provide images with clear contrast.

The available room of the above mentioned traditional projector is several times larger than that of the micro projector. So the accuracy requirements of the micro projector will be higher in comparison to the traditional projector. Because the micro projector is integrated the complete functions of the traditional projector into a relative small volume, the image quality is needed to be adjusted and optimized during the assembly process. That is the main subject of this disclosure.

The traditional projector has lager room for assembling, so adjusting mechanism can be designed thereto. In comparison, the micro project has problems, such as limited room and optical arrangement. Therefore, the micro projector needs to be redesigned for achieving the quality requirement of the projected images.

The present disclosure aims to the problem of the micro projector, and provides a micro adjustment mechanism, which is capable of adjusting assembly error and reflective error and improving the contrast ratio during the product manufacturing process, and consequently providing optimized image quality.

### SUMMARY OF THE DISCLOSURE

The present invention is to provide a combination structure for adjusting the clearance of projected images. The combination structure includes a micro projecting panel, a micro projector body, an elastic spring, a quarter wave plate set and an adjusting screw. The micro projecting panel is arranged at the peripheral of a projecting window of the micro projector body.

The present invention is to provide a combination structure for adjusting the clearance of projected images. The combination structure includes a micro projecting panel, a micro projector body, an elastic spring, a quarter wave plate set and an adjusting screw. The quarter wave plate set is inserted into an adjusting groove on the front end of the micro projector body. A supporting arm of the quarter wave plate set is arranged in an axial hole at a side of the micro projector body.

The present invention is to provide a combination structure for adjusting the clearance of projected images. The combination structure includes a micro projecting panel, a micro projector body, an elastic spring, a quarter wave plate set and an adjusting screw. The elastic spring and the adjusting screw are arranged into the axial hole of the micro projector body from the upper side and the lower side of the axial hole respectively, whereby the adjusting screw is adjusted for finely adjusting the space between the quarter wave plate set and the micro projecting panel.

### BRIEF DESCRIPTION OF THE DRAWINGS

The drawings disclose illustrative embodiments of the present disclosure. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same numeral appears in different drawings, it refers to the same or like components or steps.

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure.

FIG. 1 is an exploded view of the combination structure of the present disclosure.

FIG. 2 is a perspective view of the combination structure of the present disclosure.

While certain embodiments are depicted in the drawings, one skilled in the art will appreciate that the embodiments depicted are illustrative and that variations of those shown, as well as other embodiments described herein, may be envisioned and practiced within the scope of the present disclosure.

### DETAILED DESCRIPTION OF THE INVENTION

Illustrative embodiments are now described. Other embodiments may be used in addition or instead. Details that may be apparent or unnecessary may be omitted to save space or for a more effective presentation. Conversely, some embodiments may be practiced without all of the details that are disclosed.

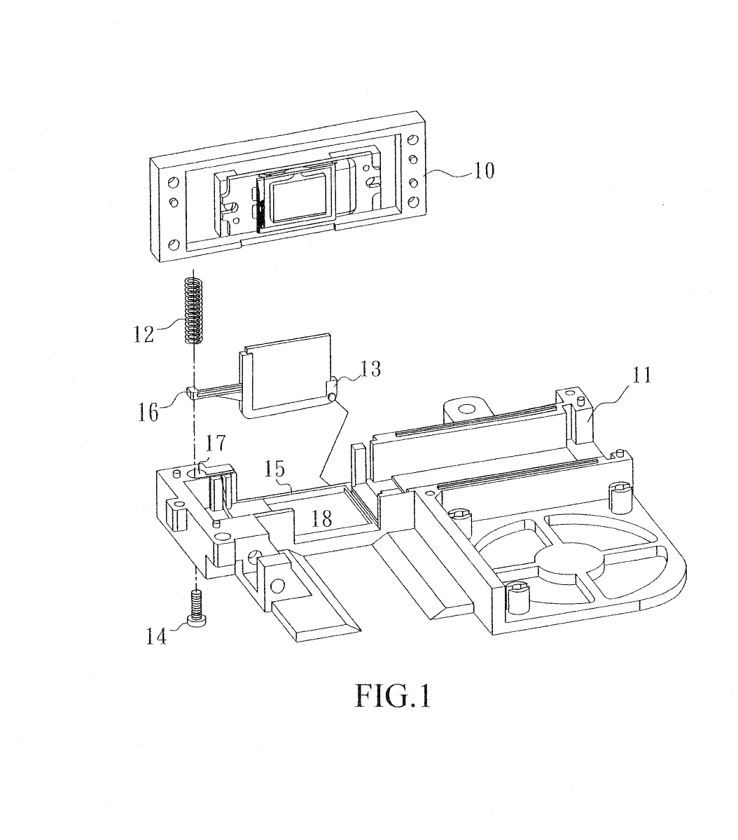

FIG. 1 is an exploded view of a combination structure of the present disclosure. The combination structure mainly includes a micro projecting panel 10, a micro projector body 11, an elastic spring 12, a quarter wave plate set 13 and an adjusting screw 14. The quarter wave plate set 13 is inserted into an adjusting groove 15 on the front end of the micro projector body 11. A supporting arm 16 of the quarter wave plate set 13 is arranged in an axial hole 17 at a side of the micro projector body 11.

As FIG. 1 shows, the elastic spring 12 and adjusting screw 14 are arranged into the axial hole 17 of the micro projector body 11 respectively from the upper side and the lower side of the axial hole 17. By adjusting the adjusting screw 14, the space between the quarter wave plate set 13 and the micro projecting panel 10 can be finely adjusted.

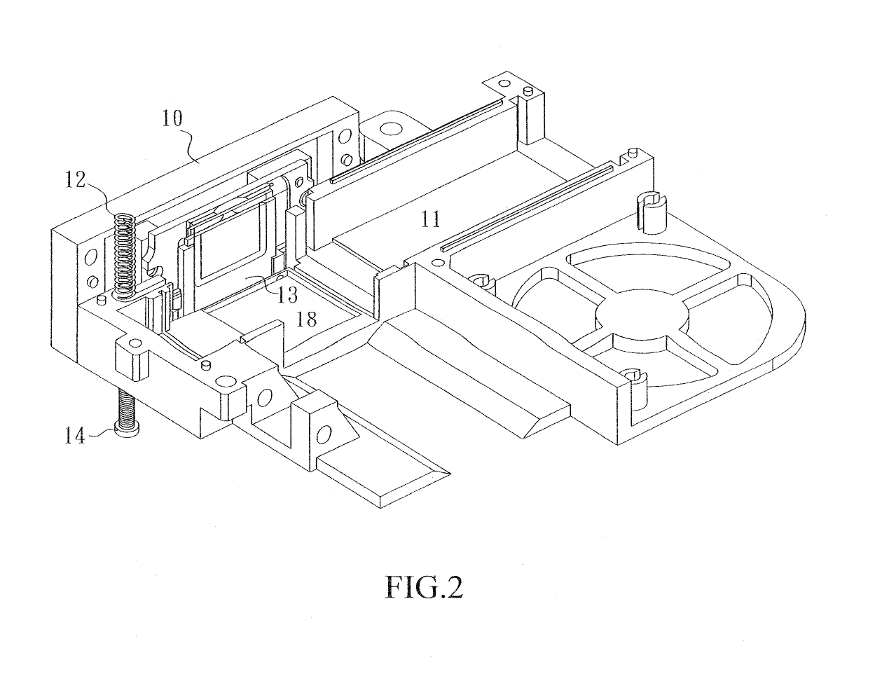

FIG. 2 is a perspective view of the combination structure of the present disclosure. The micro projecting panel 10 is arranged outside the peripheral of a projecting window 18 of the micro projector body 11 and close to the quarter wave plate set 13.

As FIG. 1 and FIG. 2 show, when the combination structure of the present disclosure is practically assembled, the quarter wave plate set 13 is inserted into the adjusting groove 15 on the front end of the micro projector body 11. And the supporting arm 16 is arranged into the axial hole 17 at the side of the micro projector body 11. Then, the micro projecting panel 10 is fixed at the peripheral of the projecting window 18 of the micro projector body 11. And the elastic spring 12 and adjusting screw 14 are arranged into the axial hole 17 respectively from the upper side and the lower side of the axial hole 17. After a cover (not shown) is covered on the micro projector body 11, the elastic spring 12 is pressed by the cover. In operation, when a light beam is reflected by the micro projecting panel 10 and forms a projecting light signal, the adjusting screw 14 can be used for finely adjusting the tension of the elastic spring 12. Thus, the space between the quarter wave plate set 13 and the micro projecting panel 10 can be finely adjusted and the quality requirement of the projected images can be achieved.

The scope of protection is limited solely by the claims, and such scope is intended and should be interpreted to be as broad as is consistent with the ordinary meaning of the language that is used in the claims when interpreted in light of this specification and the prosecution history that follows, and to encompass all structural and functional equivalents thereof

What is claimed is:

1. A combination structure for adjusting the clearance of projected images, the combination structure comprising:
a micro projecting panel, a micro projector body, an elastic spring, a quarter wave plate set and an adjusting screw,
wherein the micro projecting panel is arranged at the peripheral of a projecting window of the micro projector body; the quarter wave plate set is inserted into an adjusting groove on the front end of the micro projector body; a supporting arm of the quarter wave plate set is arranged in an axial hole at a side of the micro projector body; the elastic spring and the adjusting screw are arranged into the axial hole of the micro projector body from the upper side and the lower side of the axial hole respectively, whereby the adjusting screw is adjusted for finely adjusting the space between the quarter wave plate set and the micro projecting panel.
